(19) United States
(12) Patent Application Publication
(10) Pub. No.: US 2007/0134961 A1
(43) Pub. Date: Jun. 14, 2007

(54) Apparatus and method for interfacing XFP optical transceiver with 300-pin MSA optical transponder

(75) Inventors: Seung Il Myong, Daejeon-city (KR); Jyung Chan Lee, Daejeon-city (KR); Jong Hyun Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/635,695

(22) Filed: Dec. 7, 2006

(30) Foreign Application Priority Data
Dec. 8, 2005 (KR) 10-2005-0120108
Jul. 28, 2006 (KR) 10-2006-0071653

(51) Int. Cl. H01R 13/62

(52) U.S. Cl. 439/160

(57) ABSTRACT

Provided are an apparatus and a method for interfacing a 10 Gbps small form factor pluggable (XFP) optical transceiver with a 300-pin multi-source agreement (MSA)_optical transceiver. The apparatus includes: a direct interface providing direct interfacing paths through which signals that can be directly interfaced with one another between the XFP optical transceiver and the 300-pin MSA optical transponder; and a processor converting clock signals and data between the XFP optical transceiver and the 300-pin MSA optical transponder so that formats of the clock signals and the data coincide with one another.

### CROSS-REFERENCE TO RELATED PATENT APPLICATION

This application claims the benefits of Korean Patent Application No. 10-2005-0120108, filed on Dec. 8, 2005, and Korean Patent Application No. 10-2006-0071653, filed on Jul. 28, 2006 in the Korean Intellectual Property Office, the disclosures of which are incorporated herein in their entirety by reference.

### BACKGROUND OF THE INVENTION

1. Field of the Invention

The present invention relates to an apparatus and a method for interfacing a 10 Gbps small form factor pluggable (XFP) optical transceiver with a 300-pin multi-source agreement (MSA) optical transponder in an optical transmitting system.

2. Description of the Related Art

300-pin multi-source agreement (MSA) optical transponders are generally used for long distance transmission, but have also been used for short-distance transmission with the rapid development of 10 Gbps small form factor pluggable (XFP) technologies. However, optical transponders manufactured according to 300-pin MSA optical transponder standards are being replaced with XFP optical transceivers, and there are differences between XFP optical interface standards and 300-pin MSA interface standards. Thus, interfaces are required between the XFP optical standards and the 300-pin MSA standards.

### SUMMARY OF THE INVENTION

The present invention provides an apparatus and a method for interfacing a 10 Gbps small form factor pluggable (XFP) optical transceiver with a 300-pin MSA optical transponder in an optical transmitting system.

According to an aspect of the present invention, there is provided an apparatus for interfacing an XFP optical transceiver with a 300-pin MSA optical transceiver, including: a direct interface providing direct interfacing paths through which signals that can be directly interfaced with one another between the XFP optical transceiver and the 300-pin MSA optical transponder; and a processor converting clock signals and data between the XFP optical transceiver and the 300-pin MSA optical transponder so that formats of the clock signals and the data coincide with one another.

The processor may include: a clock controller selecting and outputting a reference clock signal received from the 300-pin MSA optical transponder or a clock signal generated by an internal clock generator; a demultiplexer demultiplexing the clock signal output from the clock controller and data output from the XFP optical transceiver and outputting the demultiplexed clock signal and data to the 300-pin MSA optical transponder; and a multiplexer multiplexing data received from the 300-pin MSA optical transponder and outputting the multiplexed data to the XFP optical transceiver.

The demultiplexer may perform the demultiplexing at a ratio of 1:16. The multiplexer may perform the multiplexing at a ratio of 16:1.

The direct interface may be a buffer or an inverter.

The apparatus may further include a power supply unit receiving power from the 300-pin MSA optical transponder and supplying the power to the apparatus.

The apparatus may further include a microprocessor controlling the apparatus and sensing errors.

According to another aspect of the present invention, there is provided a method of interfacing an XFP optical transceiver with a 300-pin MSA optical transponder, including: determining whether signals can be directly interfaced with one another between the XFP optical transceiver and the 300-pin MSA optical transponder; if it is determined that the signals can be directly interfaced with one another between the XFP optical transceiver and the 300-pin MSA optical transponder, providing direct interfacing paths through which the signals directly interface with one another; and if it is determined that the signals cannot be directly interfaced with one another between the XFP optical transceiver and the 300-pin MSA optical transponder, converting clock signals and data so that formats of the clock signals and data coincide with one another.

The converting of the clock signals and data so that the formats of the clock signals and data coincide with one another may include: selecting and outputting one of a reference clock signal received from the 300-pin MSA optical transponder and a generated clock signal; demultiplexing the selected clock signal and data output from the XFP optical transceiver and outputting the demultiplexed clock signal and data to the 300-pin MSA optical transponder; and multiplexing data received from the 300-pin MSA optical transponder and outputting the multiplexed data to the XFP optical transceiver.

The multiplexing may be performed at a ratio of 16:1, and the demultiplexing may be performed at a ratio of 1:16.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for interfacing a 10 Gbps small form factor pluggable (XFP) optical transceiver with a 300-pin MSA optical transponder according to an embodiment of the present invention;

FIG. 2 is a block diagram of a direct interface 120 of FIG. 1;

FIG. 3 is a block diagram of a processor 130 of FIG. 1;

FIG. 4 is a block diagram of a 300-pin connector generating control signals necessary for performing functions of a demultiplexer 133 and a multiplexer 135 of the processor 130 illustrated in FIG. 1;

FIG. 5 is a block diagram of a power supply unit 140 of FIG. 1;

FIG. 6 is a block diagram of a microprocessor 150 of FIG. 1; and

FIG. 7 is a flowchart illustrating a method of interfacing an XFP optical transceiver with a 300-pin MSA optical transponder according to an embodiment of the present invention.

### DETAILED DESCRIPTION OF THE INVENTION

The present invention will now be described in detail by explaining preferred embodiments of the invention with reference to the attached drawings.

In general, since a 300-pin MSA optical transponder has 300 signal definitions, and an XFP optical transceiver has 30 signal definitions, interface functions are required for a proper interface between the two. The interface functions must include a signal demultiplexing function, a signal multiplexing function, a microprocessor function, a power re-supplying function, and an interfacing function between two different signal standards.

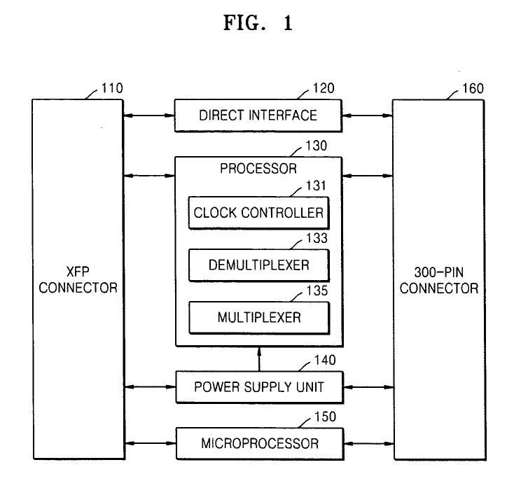

Therefore, the functions suggested in the present invention must be included to perform proper interfacing between two standards. This will be described with reference to the attached drawings. An XFP connector 110 illustrated in FIG. 1 indicates an XFP optical transceiver, and a 300-pin connector 160 indicates a 300-pin MSA optical transponder.

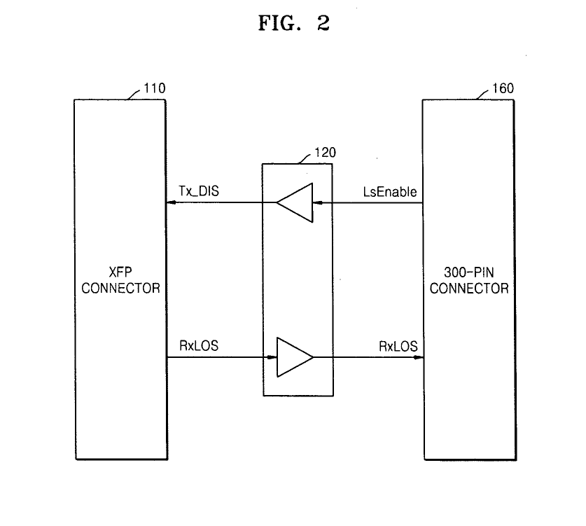

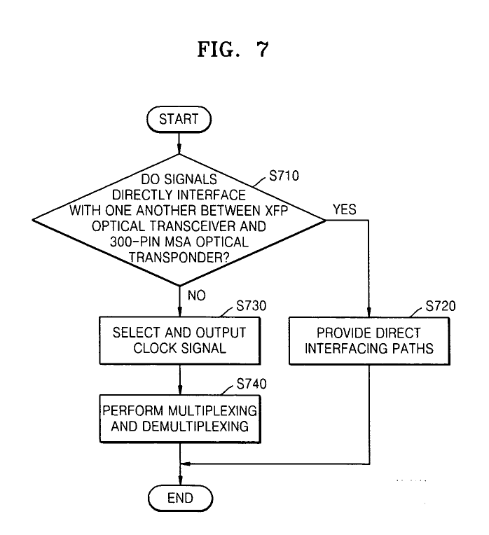

Referring to FIGS. 1 and 7, an apparatus for interfacing an XFP optical transceiver with a 300-pin MSA optical transponder includes a direct interface 120, a processor 130, a power supply unit 140, and a microprocessor 150 to interface the XFP connector 110 with the 300-pin connector 160. Interfacing functions will be described in detail with reference to FIGS. 2 through 6. The XFP connector 100 is required to interface the XFP optical transceiver with the 300-pin MSA optical transponder. If an existing 300-pin MSA optical transponder is mounted, the 300-pin connector 160 requires 300 pins. Thus, if the 300-pin MSA optical transponder is replaced with the XFP optical transceiver, the 300-pin connector 160 is required. In operation S710, a determination is made as to whether signals can be directly interfaced with one another between the XFP connector 110 and the 300-pin connector 160. If it is determined in operation S710 that the signals can be directly interfaced with one another between the XFP connector 110 and the 300-pin connector 160, an interfacing path is suggested through the direct interface 120 in operation S720. The direct interface 120 interfaces signals received from the XFP connector 110 with the 300-pin connector 160 and signals received from the 300-pin connector 160 with the XFP connector 110 to process the signals. In operations S710 and 720, signals which cannot be directly interfaced with one another are clocked, multiplexed, and demultiplexed by the processor 130. The processor 130 operates as a demultiplexer, a multiplexer, and a clock buffer to convert clock signals and data so as to transmit the signals received from the XFP connector 100 or the 300-pin connector 160 to the 300-pin connector 160 or the XFP connector 110. The power supply unit 140 distributes power received from the 300-pin connector 160 into the apparatus and the XFP connector 110. The microprocessor 150 transmits control signals to the XFP connector 110 and supervisory signals to the 300-pin connector 160.

The direct interface 120 will be described in more detail with reference to FIG. 2. The direct interface 120 directly interfaces the signals of the XFP connector 110 with the signals of the 30-pin connector 160. In other words, a signal LsEnable of the 300-pin connector 160 is directly interfaced with a signal Tx_DIS of the XFP connector 110. Also, a signal RxLOS of the XFP connector 110 is directly interfaced with a signal RxLOS of the 300-pin connector 160. As described above, signals are interfaced with one another through the direct interface 120. Here, the direct interface 120 may be a buffer or an inverter.

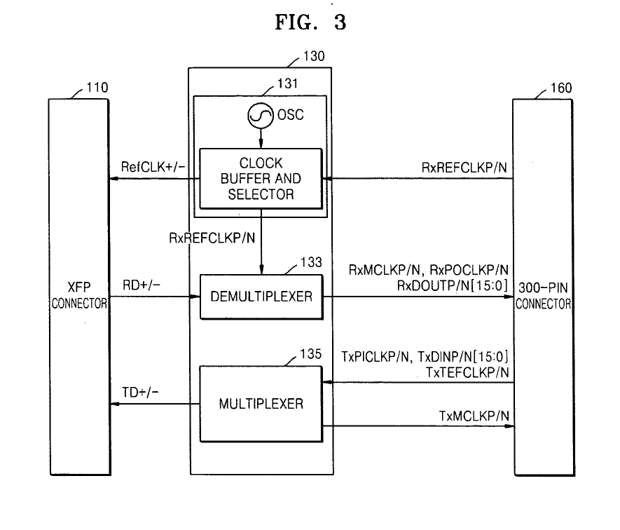

FIG. 3 is a block diagram of the processor 130 of FIG. 1. Referring to FIG. 3, a clock processor 131, a demultiplexer 133, and a multiplexer 135 of the processor 130 perform the following functions to properly interface clock signals and data between the XFP connector 110 and the 300-pin connector 160. A signal RxREFCLKP/N received from the 300-pin connector 160 is interfaced with a signal RefCLK+/− of the demultiplexer 133 or the XFP connector 110 through the clock processor 131. Also, a signal transmitted from an internal OSC must be provided to the demultiplexer 133 or the signal RefCLK+/−. Thus, the clock processor 131 also performs a signal distribution function. The demultiplexer 133 mainly demultiplexes signals RD+/− at a ratio of 1:16, and the demultiplexed signals are interfaced with a signal RxDOUTP/N[15:0] of the 300-pin connector 160. The demultiplexer 133 also includes signals RxMCLKP/N and RxPOCLKP/N to interface with the 300-pin connector 160. The multiplexer 135 mainly multiplexes a signal TxDINP/N[15:0] received from the 300-pin connector 160 at a ratio of 16:1 and transmits the multiplexed signal TxDINP/N[15:0] to a signal TD+/− of the XFP connector 110. The multiplexer 133 also interfaces signals TxPICLKP/N, TxREFCLKP/N, and TxMCLKP/N with one another.

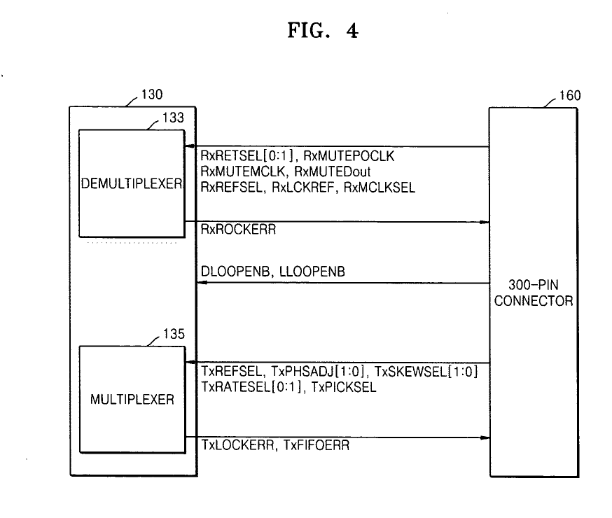

FIG. 4 is a block diagram of the 300-pin connector generating control signals necessary for performing the functions of the demultiplexer 133 and the multiplexer 135 of the processor 130 illustrated in FIG. Referring to FIG. 4, control and supervisory signals of the 300-pin connector 160 that must be accepted by the demultiplexer 133 and the multiplexer 135 are shown. Signals including RxRESESEL[0:1], RxMUTEPOCLK, RXMUTEMCLK, RxMUTEDout, RxREFSEL, RxLCKREF, RxMCLKSEL are control signals of the 300-pin connector 160 for demultiplexing. These signals must be accepted by the demultiplexer 133. The demultiplexer 133 must output a signal RxROCKERR to the 300-pin connector 160. Signals DLOOPENB and LLOOPENB are directly transmitted to the processor 130 and are used to control data loopback between the demultiplexer 133 and the multiplexer 135. Signals including TxFIFORES, TxLINETIMSEL, TxREFSEL, TxPHSADJ[1:0], TxSEKWSEL[1:0], TxRATESEL[0:1], and TxPICKSEL are output from the 300-pin connector 160 to control the multiplexer 135 and are accepted by the multiplexer 135. The multiplexer 135 also outputs signals including TxLOCKERR and TxFIFOERR to the 300-pin connector 160.

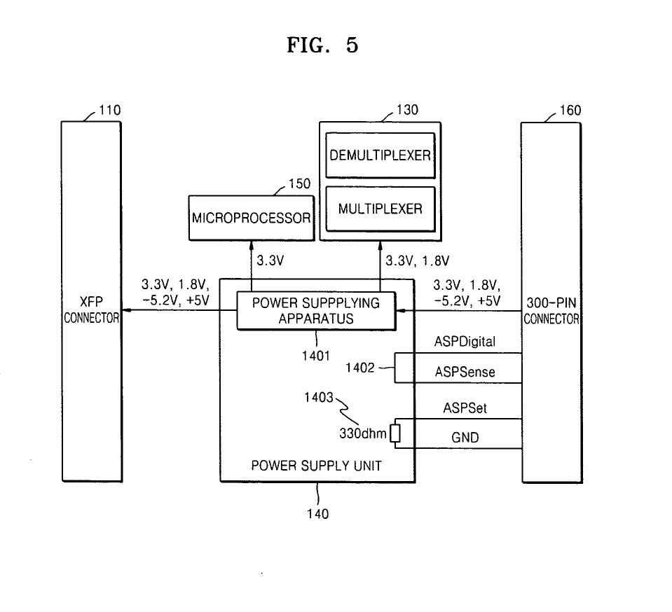

FIG. 5 is a block diagram of the power supply unit 140 of FIG. 1. The power supply unit 140 is supplied with 3.3 V, 1.8 V, −5.2 V, and 5 V from the 300-pin connector 160 and uses a power supplying apparatus 1401 to supply 3.3 V and 1.8 V to the demultiplexer 133 and the multiplexer 135, 3.3 V to the microprocessor 150, and 3.3 V, 1.8 V, −5.2 V, and 5 V to the XFP connector 110. The power supplying apparatus 1401 includes DC (Direct Current)-DC converter or a power splitting means. Portions 1402 and 1403 of the power supply unit 140 performing adaptable power supply (APS) functions are connected to the 300-pin connector 160.

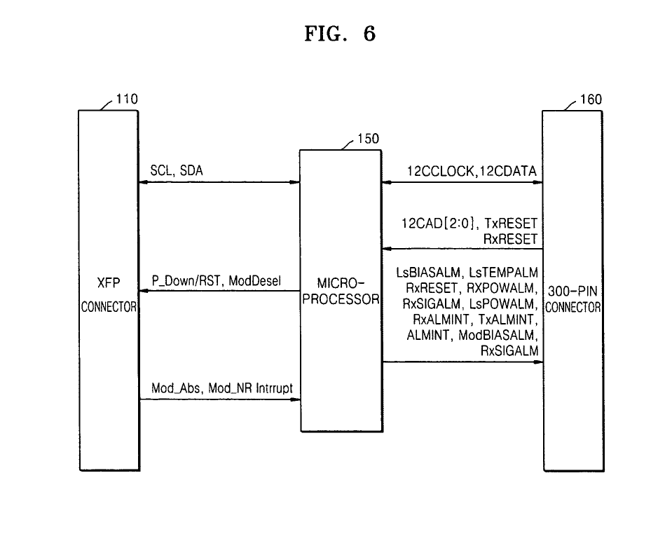

FIG. 6 is a block diagram of a microprocessor 150 of FIG. 1, showing signals which must be accepted by the microprocessor 150. Signals SCL, SDA, 12CCLOCK, and 12CDATA are 2-line serial communication signals, and signals P_Down/RST, ModDesel, 12CAD[2:0], TxRESET, and RxRESET are reset signals. Signals Mod-Avs, Mod_NR Interrupt, LsBIASALM, LsTEMPALM, RxRESET, RxPOWLM, RxALMINT, TxALMINT, ALMINT, ModBIASALM, and RxSIGALM are signals indicating state information or warnings, processed in the microprocessor 150, and transmitted to the XFP connector 110 or the 300-pin connector 160. The names and functions of signals in the above description may be easily understood by those skilled in the art, and thus their detailed descriptions have been omitted.

As described above, an apparatus and a method for interfacing an XFP optical transceiver with a 300-pin MSA optical transponder can be applied between two different interfacing standards, i.e. XFP optical transceiver standards and 300-pin MSA optical transponder standards. As a result, the two different standards can easily interface with each other, and the XFP optical transceiver can be made compatible with the 300-pin MSA optical transponder.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An apparatus for interfacing a 10 Gbps small form factor pluggable (XFP) optical transceiver with a 300-pin multi-source agreement (MSA) optical transceiver, comprising:
a direct interface providing direct interfacing paths through which signals that can be directly interfaced with one another between the XFP optical transceiver and the 300-pin MSA optical transponder; and
a processor converting clock signals and data between the XFP optical transceiver and the 300-pin MSA optical transponder so that formats of the clock signals and the data coincide with one another.

2. The apparatus of claim 1, wherein the processor comprises:
a clock controller selecting and outputting one of a reference clock signal received from the 300-pin MSA optical transponder and a clock signal generated by an internal clock generator;
a demultiplexer demultiplexing the clock signal output from the clock controller and data output from the XFP optical transceiver and outputting the demultiplexed clock signal and data to the 300-pin MSA optical transponder; and
a multiplexer multiplexing data received from the 300-pin MSA optical transponder and outputting the multiplexed data to the XFP optical transceiver.

3. The apparatus of claim 2, wherein the demultiplexer performs the demultiplexing at a ratio of 1:16.

4. The apparatus of claim 2, wherein the multiplexer performs the multiplexing at a ratio of 16:1.

5. The apparatus of claim 1, wherein the direct interface is one of a buffer and an inverter.

6. The apparatus of claim 1, further comprising a power supply unit receiving power from the 300-pin MSA optical transponder and supplying the power to the apparatus.

7. The apparatus of claim 1, further comprising a microprocessor controlling the apparatus and sensing errors.

8. A method of interfacing an XFP optical transceiver with a 300-pin MSA optical transponder, comprising:
determining whether signals can be directly interfaced with one another between the XFP optical transceiver and the 300-pin MSA optical transponder;
if it is determined that the signals can be directly interfaced with one another between the XFP optical transceiver and the 300-pin MSA optical transponder, providing direct interfacing paths through which the signals directly interface with one another; and
if it is determined that the signals cannot be directly interfaced with one another between the XFP optical transceiver and the 300-pin MSA optical transponder, converting clock signals and data so that formats of the clock signals and data coincide with one another.

9. The method of claim 8, wherein the converting of the clock signals and data so that the formats of the clock signals and data coincide with one another comprises:
selecting and outputting one of a reference clock signal received from the 300-pin MSA optical transponder and a generated clock signal;
demultiplexing the selected clock signal and data output from the XFP optical transceiver and outputting the demultiplexed clock signal and data to the 300-pin MSA optical transponder; and
multiplexing data received from the 300-pin MSA optical transponder and outputting the multiplexed data to the XFP optical transceiver.

10. The method of claim 9, wherein the multiplexing is performed at a ratio of 16:1, and the demultiplexing is performed at a ratio of 1:16.

11. A computer-readable recording medium having embodied thereon a computer program for executing the method of claim 8.
